(19) United States
(12) Patent Application Publication
(10) Pub. No.: US 2005/0030906 A1
(43) Pub. Date: Feb. 10, 2005

(54) System and method for configuring a computer network route

(76) Inventors: Changjian Lou, Shenzhen (CN); Tang He, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/830,199

(22) Filed: Apr. 21, 2004

(30) Foreign Application Priority Data
Aug. 8, 2003 (TW) 92121863

(51) Int. Cl. H04L 12/28

(52) U.S. Cl. 370/254

(57) ABSTRACT

A system (5) for configuring a computer network route includes a user interface for providing a configuration interface for a user, a configuration manager (52) for providing configuration services for the user interface, a routing information protocol (RIP) interface (54), a Zebra daemon (56) for managing a route, an RIP daemon (57) for performing RIP, and a kernel routing table (58) for recording routing information of the system. The daemon communicates with the configuration manager through the RIP interface, and communicates with the RIP daemon by exchanging information. The RIP daemon communicates with the configuration manager through the RIP interface. A related method for configuring a route is also provided.

### BACKGROUND OF THE INVENTION

1. Field of the Invention

The present invention relates to systems and methods for configuring computer network routes, and more particularly to a system and method for configuring a route on the basis of routing information protocol (RIP).

2. Description of Related Art

RIP is a commonly used interior gateway protocol that is created especially for small office and home office (SOHO) networks. RIP was developed in the 1970s at the Xerox Lab as a part of the Xerox network system (XNS) routing protocol, and is based on the Bellman-Ford algorithms.

According to RIP, a first router in a network exchanges routing information with another router in the network by broadcasting user datagram protocol (UDP) data packets. The first router transmits the routing information every 30 seconds, and each other router updates the routes in a routing table after receiving the routing information. The routing table is stored in each of the other routers. If any of the other routers does not receive the routing information within 180 seconds and does not update the routes in a routing table, such router regards the routes as being unusable. If there is still no update within 240 seconds, such router removes the routes from the routing table. RIP employs “hop count” as a metric value to rate the value of different routes. The “hop count” is the number of routers that are traversed in a route. A directly connected network has a metric value of zero, and an unreachable network has a metric value of 16. That is, the minimum of the metric value is zero, and the maximum of the metric value is 16. The metric value range makes RIP suitable for SOHO networks.

In order to support RIP, a router needs a special software system for recording routing information, and for configuring and updating routes. The routing information includes IP addresses of other routers, a subnet mask, metric values representing different distances to the other routers, and so on. With a suitable software system, a user can administer and maintain the routes of the router conveniently.

### SUMMARY OF THE INVENTION

Accordingly, a primary object of the present invention is to provide a system for configuring a computer network route on the basis of RIP.

Another object of the present invention is to provide a method for configuring a computer network route on the basis of RIP.

In order to fulfill the above-mentioned primary object, the present invention provides a system for configuring a computer network route. The system comprises a user interface for providing a configuration interface for a user, a configuration manager for providing configuration services for the user interface, an RIP interface, a managing daemon for managing a route, an RIP daemon for performing RIP, and a kernel routing table for recording routing information of the system. The managing daemon communicates with the configuration manager through the RIP interface, and communicates with the RIP daemon by exchanging information. The RIP daemon communicates with the configuration manager through the RIP interface.

In order to fulfill the other above-mentioned object, the present invention provides a method for configuring a computer network route. The method comprises the following steps: (a) transmitting a command line to a configuration manager; (b) determining whether there is a match between the command line and any of command lines registered in the configuration manager; (c) ordering an RIP interface to transmit a message to a managing daemon or an RIP daemon if there is a match; (d) receiving the message, and generating a response to the message; and (e) returning an acknowledgement message to the RIP interface.

Other objects, advantages and novel features of the present invention will become more apparent from the following detailed description when taken in conjunction with the accompanying drawings, in which:

### BRIEF DESCRIPTION OF THE DRAWINGS

FIG. 1 is a data flow chart of a system for configuring a computer network route according to the present invention;

FIG. 2 is a flow chart of an exemplary method for configuring a computer network route by using a Zebra daemon according to the present invention; and

FIG. 3 is a flow chart of an exemplary method for configuring a computer network route by using an RIP daemon according to the present invention.

### DETAILED DESCRIPTION OF THE INVENTION

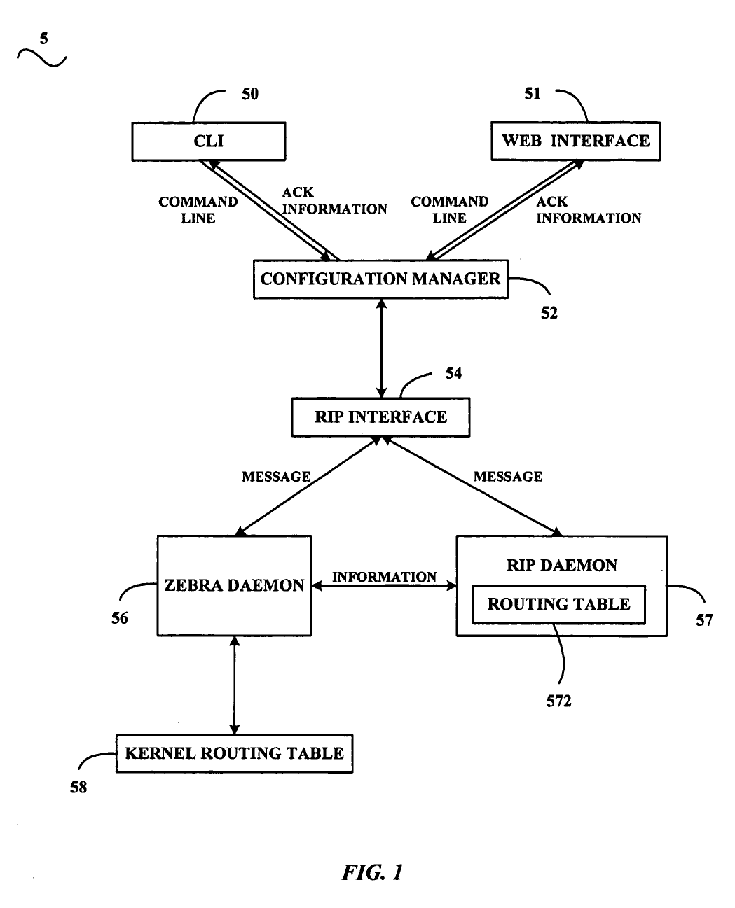

FIG. 1 is a data flow chart of a system 5 for configuring a computer network route according to the present invention. In the exemplary embodiment of the present invention, the system 5 is an embedded software system operating in a Linux environment. The system 5 comprises a command line interface (CLI) 50, a web interface 51, a configuration manager 52 for providing configuration services for the CLI 50 and the web interface 51, an RIP interface 54, a Zebra daemon 56 for managing the route, an RIP daemon 57 for performing RIP, and a kernel routing table 58 for recording routing information of the system 5. The CLI 50 and the web interface 51 are for providing a configuration interface for a user. The RIP daemon 57 comprises a routing table 572 for recording a part of the routing information of the system 5. The kernel routing table 58 comprises IP addresses of other routers, a subnet mask, metric values representing different distances to other routers, and so on.

When the system 5 is run, the user inputs a command line through the CLI 50 or the web interface 51. The CLI 50 or the web interface 51 transmits the command line to the configuration manager 52. If the command line is matched to any of command lines that have been registered in the configuration manager 52, the configuration manager 52 orders the RIP interface 54 to transmit a message to the Zebra daemon 56 or the RIP daemon 57. The Zebra daemon 56 or the RIP daemon 57 generates a response to the message, and then returns an acknowledgement (ACK) message about the response to the RIP interface 54. The configuration manager 52 obtains ACK information about the response from the ACK message, and then forwards the ACK information to the CLI 50 or the web interface 51. The user obtains the ACK information from the CLI 50 or the web interface 51 in real time.

In the exemplary embodiment of the present invention, the Zebra daemon 56 is a routing manager for updating the kernel routing table 58. The Zebra daemon 56 is also used for redistributing the routes among different routing protocols. Since RIP needs interface information maintained by the Zebra daemon 56, it is necessary to run the Zebra daemon 56 and the RIP daemon 57 simultaneously. In an alternative exemplary embodiment, the Zebra daemon 56 can be replaced by a Gated daemon. The Gated daemon is a commonly used routing software package operating in the Linux environment.

In the exemplary embodiment of the present invention, the RIP daemon 57 supports RIP version 1 and RIP version 2. The RIP daemon 57 is mainly provided for maintaining the routing table 572 thereof, and for transmitting updating route information to a neighboring router periodically. The routing table 572 comprises an IP address of the first router in the route and a metric value to the destination router. The updating route information comprises all the content of the routing table 572.

In the exemplary embodiment of the present invention, the RIP interface 54, the Zebra daemon 56 and the RIP daemon 57 communicate with one another by way of a UNIX domain socket. The Zebra daemon 56 and the RIP daemon 57 communicate with the RIP interface 54 by using messages, and communicate with each other by using the information on updating of the kernel routing table 58. Table 1 below shows a format of a message. “Length” in table 1 is the number of the byte of the message. The minimum value of the “Length” is 3 bytes according to the format of the message. The RIP daemon 57 calls an RIP daemon interface (not shown) according to “Command Index” in table 1. “Payload” in table 1 is the content of the message.

TABLE 1

| | | | |
|---|---|---|---|
| Byte 0 | Byte 1 | Byte 2 | . . . |

| | | |
|---|---|---|
| Length | Command Index | Payload |

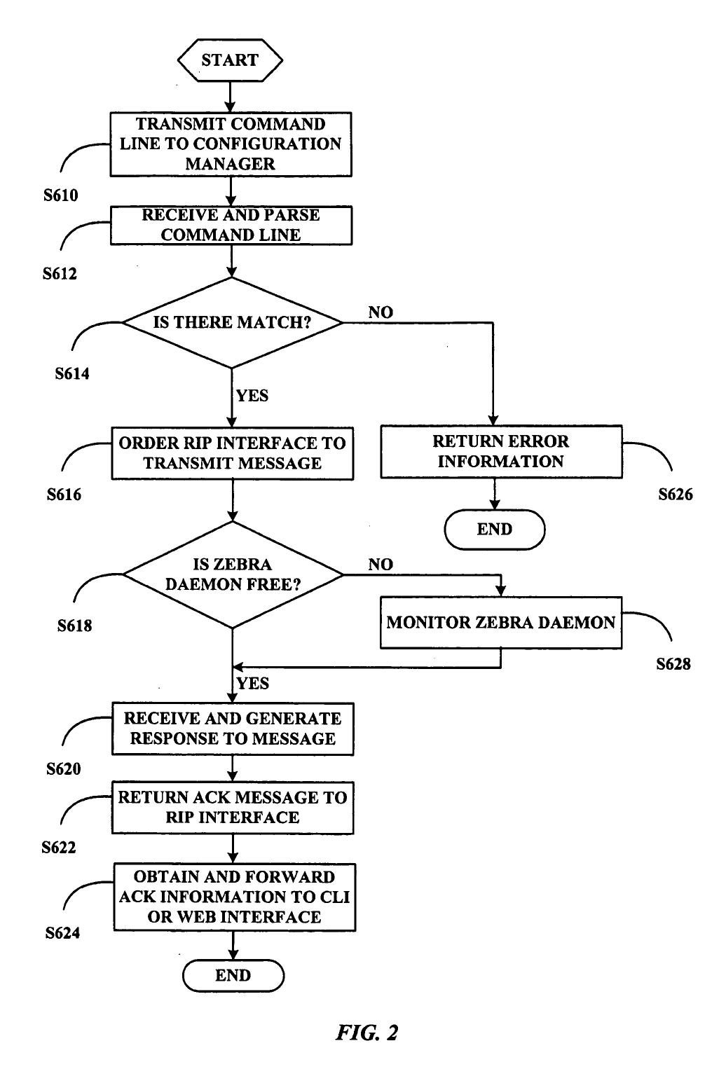

FIG. 2 is a flow chart of an exemplary method for configuring a computer network route by using the Zebra daemon 56 according to the present invention. At step S610, the CLI 50 or the web interface 51 transmits a command line input by the user to the configuration manager 52. At step S612, the configuration manager 52 receives and parses the command line. At step S614, the configuration manager 52 determines whether there is a match between the command line input by the user and any of the command lines registered therein. If so, the procedure goes directly to step S616. Otherwise, the procedure goes to step S626. At step S626, the configuration manager 52 returns error information to the CLI 50 or the web interface 51. At step S616, the configuration manager 52 orders the RIP interface 54 to transmit a message to the Zebra daemon 56.

At step S618, the RIP interface 54 determines whether the Zebra daemon 56 is free. If so, the procedure goes directly to step S620. Otherwise, the procedure goes to step S628. At step S628, the RIP interface 54 monitors the Zebra daemon 56 until the Zebra daemon 56 is free. At step S620, the Zebra daemon 56 receives the message, and then generates a response to the message. At step S622, the Zebra daemon 56 returns an acknowledgement (ACK) message about the response to the RIP interface 54. At step S624, the configuration manager 52 obtains ACK information about the response from the ACK message, and then forwards the ACK information to the CLI 50 or the web interface 51. The user obtains the ACK information from the CLI 50 or the web interface 51 in real time.

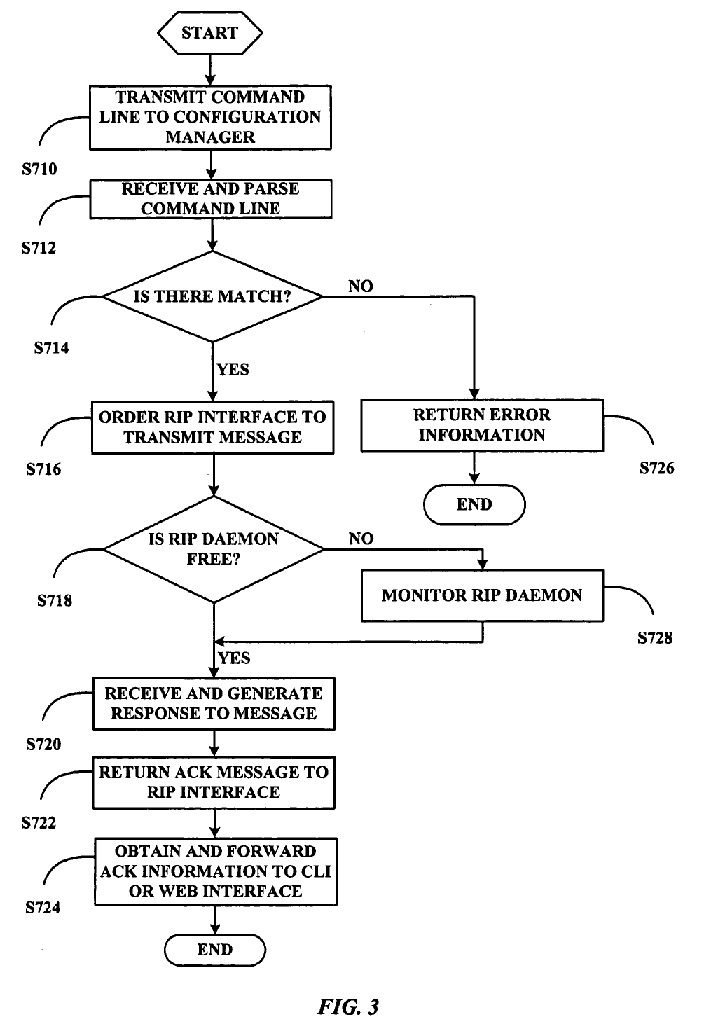

FIG. 3 is a flow chart of an exemplary method for configuring a computer network route by using the RIP daemon 57 according to the present invention. At step S710, the CLI 50 or the web interface 51 transmits a command line input by the user to the configuration manager 52. At step S712, the configuration manager 52 receives and parses the command line. At step S714, the configuration manager 52 determines whether there is a match between the command line input by the user and any of the command lines registered therein. If so, the procedure goes directly to step S716. Otherwise, the procedure goes to step S726. At step S726, the configuration manager 52 returns error information to the CLI 50 or the web interface 51. At step S716, the configuration manager 52 orders the RIP interface 54 to transmit a message to the RIP daemon 57.

At step S718, the RIP interface 54 determines whether the RIP daemon 57 is free. If so, the procedure goes directly to step S720. Otherwise, the procedure goes to step S728. At step S728, the RIP interface 54 monitors the RIP daemon 57 until the RIP daemon 57 is free. At step S720, the RIP daemon 57 receives the message, and then generates a response to the message. At step S722, the RIP daemon 57 returns an ACK message about the response to the RIP interface 54. At step S724, the configuration manager 52 obtains ACK information about the response from the ACK message, and then forwards the ACK information to the CLI 50 or the web interface 51. The user obtains the ACK information from the CLI 50 or the web interface 51 in real time.

While a preferred embodiment and preferred methods of the present invention have been described above, it should be understood that they have been presented by way of example only and not by way of limitation. Thus the breadth and scope of the present invention should not be limited by the above-described exemplary embodiment and methods, but should be defined only in accordance with the following claims and their equivalents.

1. A system for configuring a computer network route, the system comprising:
a user interface for providing a configuration interface for a user;
a configuration manager for providing configuration services for the user interface;
a routing information protocol (RIP) interface;
a managing daemon for managing a route, the managing daemon communicating with the configuration manager through the RIP interface;
an RIP daemon for performing RIP, the RIP daemon communicating with the configuration manager through the RIP interface; and
a kernel routing table for recording routing information of the system;
wherein the managing daemon communicates with the RIP daemon by exchanging information.

2. The system as claimed in claim 1, wherein the user interface is a command line interface or a web interface.

3. The system as claimed in claim 1, wherein the managing daemon is a Zebra daemon or a Gated daemon.

4. The system as claimed in claim 3, wherein the managing daemon is used for updating the kernel routing table.

5. The system as claimed in claim 4, wherein the managing daemon is used for redistributing the routes among different routing protocols.

6. The system as claimed in claim 1, wherein the RIP daemon comprises a routing table.

7. The system as claimed in claim 6, wherein the RIP daemon is used for transmitting updating route information periodically.

8. The system as claimed in claim 1, wherein the RIP interface, the managing daemon and the RIP daemon communicate with one another through a UNIX domain socket.

9. A method for configuring a computer network route, the method comprising the following steps:
(a) transmitting a command line to a configuration manager;
(b) determining whether there is a match between the command line and any of command lines registered in the configuration manager;
(c) ordering a routing information protocol (RIP) interface to transmit a message to a managing daemon or an RIP daemon if there is a match;
(d) receiving the message, and generating a response to the message; and
(e) returning an acknowledgement message to the RIP interface.

10. The method as claimed in claim 9, further comprising the step of returning error information to a user interface if there is no match.

11. The method as claimed in claim 9, further comprising the following steps before step (d):
(1) determining whether the managing daemon or the RIP daemon is free; and
(2) monitoring the managing daemon or the RIP daemon if the managing daemon or the RIP daemon is not free.

12. The method as claimed in claim 9, further comprising after step (e) the step of obtaining acknowledgement information from the acknowledgement message, and forwarding the acknowledgement information to a user interface.
